(19) United States
(12) Patent Application Publication
(10) Pub. No.: US 2007/0205886 A1
(43) Pub. Date: Sep. 6, 2007

(54) RF/acoustic person locator system

(76) Inventors: Steve D. Huseth, Plymouth, MN (US); Soumitri N. Kolavennu, Minneapolis, MN (US); Anoop K. Mathur, Shoreview, MN (US); Thomas A. Plocher, Hugo, MN (US); Kristen Law, Minneapolis, MN (US)

Correspondence Address: Kris T. Fredrick, Esq.;Patent Services, Honeywell International Inc., 101 Columbia Road, Morristown, NJ, 07962, US

(21) Appl. No.: 11/366,849

(22) Filed: Mar. 1, 2006

(51) Int. Cl. G08B 1/08; G08B 23/00

(52) U.S. Cl. 340/539.15; 340/573.4; 340/539.21; 340/539.13

(57) ABSTRACT

A locator system, including a transmitter device such as a PAS device to be carried by a first individual such as a first responder in a fire fighting event. The transmitter transmits an acoustic sound and a RF pulse. A RF receiver is carried by a second individual, such as someone dispatched to rescue the first individual. The receiver receives the acoustic sound using a pair of acoustic receivers and RF pulse and calculates the distance to and bearing of the transmitter device. Both transmitter and receiver may include temperature data for calculating the ambient speed of sound. A display informs the second individual of the distance and bearing. The acoustic sound receivers are spaced from each other to permit triangulation calculations to determine the distance and bearing. The transmitter is activated by the first individual by choice and when the first individual is motionless for a predetermined time.

### FIELD OF THE INVENTION

The present invention relates to a first responder system for locating persons, More particularly, the invention relates to a person locating system using both RF signals and acoustic signals.

### BACKGROUND OF THE INVENTION

Often times first responders experience danger and difficulty when going to a natural or human-made disasters. When rescues are attempting to search for victims in a building, for example, smoke and fire can obscure the rescuer's vision. Accidents happen.

Current locator systems depend on acoustic noise that can be heard. However, in the confusion of a rescue situation, the acoustic alarm is insufficient. In a fire domain, smoke and debris prevent visual contact between a first responder and the command center, such as a fire truck or control center. While sound does travel through smoke, without visual contact it is not easy to determine the distance to the first responder.

First responders also are at risk in fire and other disaster scenes and, sometimes, the first responder may be injured by smoke inhalation, falling debris, collapsing walls or floors. Some times the stress, physical and mental, causes a first responder to fall ill. Even when not totally disabled, the first responder may not be able to leave an area due a partial loss of mobility. Also, the responder may need to take care of another victim.

Presently, firefighters and other first responders carry what is known as a personal alarm sounder or PAS. The PAS device can be manually turned on and also may have a feature of turning itself on if the person carrying the PAS device is inactive for a period of time, such as thirty seconds or the like. Use of the PAS device has not resolved all the problems encountered by first responders and others needing to be rescued. The sound is loud enough to be heard over a distance, but there is no way to determine how far away the PAS device user is. Direction is not always easy or even possible to determine at large distances.

It would be of advantage in the art if a first responder locator system could be developed that would permit accurate measurement of the distance to the alarm and the precise direction from which it is coming.

Yet another advantage would be if a system could be provided that would permit a control operation to locate a first responder in need of assistance quickly and safely.

Still another advantage would be if a first responder location system would be provided that permitted a rescue team to carry a portion of the system that interacts with the device carried by a fallen first responder or other person in need.

Other advantages will appear hereinafter.

### SUMMARY OF THE INVENTION

It has now been discovered that the above and other advantages of the present invention may be obtained in the following manner. Specifically, the present invention provides a system and method that permits rescuers of a fallen first responder, or other individual in distress, in a damaged or burning building to determine the precise distance and direction to the individual to permit rapid response in emergency situations.

The system consists of an alarming device attached to the uniform, for example, of each first responder and a portable receiver device is carried by each rescuer. The alarming device may be activated either by explicit action by the wearer or automatic activation when the device detects lack of activity indicating an emergency condition. The alarming device then emits both a loud acoustic alarm that can be heard by rescuers in the area together with a RF beacon that can be received by RF receivers in the area.

The alarming device or transmitter may be a personal alarm sounder or PAS that has been modified to transmit acoustic sound pulses, RF signal pulses and temperature data imbedded in the RF signal pulses. The receiver device is a RF receiver and may be imbedded in an IR camera to give additional information. The RF receiver will have a pair of acoustic receivers that are spaced from each other to permit triangulation to calculate distance and bearing. The receiver device will also measure ambient temperature and receive the imbedded temperature data in the RF signal pulses to compensate for temperature in calculating the speed of sound in the environment where the system is employed. The display will tell the rescuer what is the direction to and distance from the display to the alarming device.

### BRIEF DESCRIPTION OF THE DRAWINGS

For a more complete understanding of the invention, reference is hereby made to the drawings, in which:

FIG. 1 is a schematic block diagram illustrating the preferred embodiment of the present invention.

### DETAILED DESCRIPTION OF THE PREFERRED EMBODIMENT

The present invention provides for substantial improvements in rescue systems such as fire fighting environments where there has been a significant amount of visual impairment. It is an improvement on systems that depend solely on acoustic noise that can be heard. The present invention eliminates or substantially reduces the confusion of a rescue situation that often renders the acoustic alarm alone as insufficient. This invention provides the precise distance and direction to the fallen first responder or other individual to make rescue efforts faster and safer.

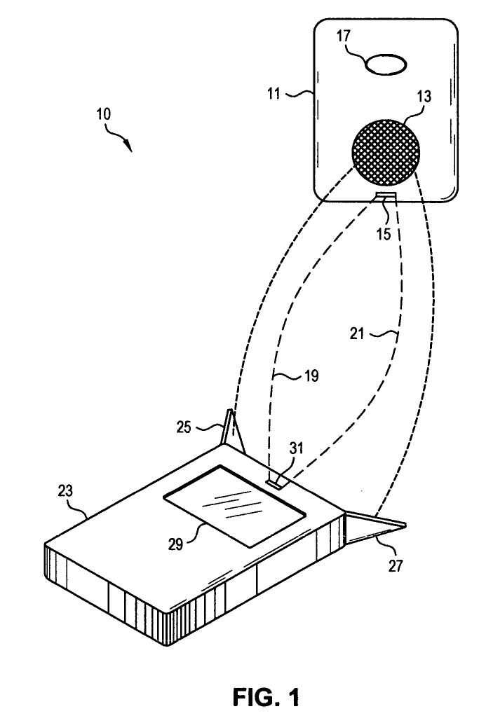

As shown in FIG. 1, the system, 10 generally, includes a transmitting device 11 such as an enhanced personal alarm sounder or PAS is to be attached to the uniform of each first responder or other person of interest. Transmitting device 11 has an acoustic speaker 13, a RF signal transmitter 15 and an actuator button 17. Actuator button 17 includes a sensor device that detects lack of motion and turns on actuator button after a predetermined time of no activity or motion, such as when a person has fallen or collapsed.

One PAS device is manufactured by Grace Industries, Inc., under the product name Super Pass™ is designed to emit a sound alarm when needed. It is turned on automatically when taken from storage, and is sensitive to lack of motion or activity. Its product information states that it capable of transmitting a series of loud attention getting audio tones when activated. When there is a lack of mtion for approximately 18 to 23 seconds, the unit goes to a ‘pre-alarm’ mode and produce an audible ‘pre-alert’ signal. After a lack of motion for 30 to 35 seconds, the unit goes into an ‘alarm’ mode and transmits a loud alarm signal.

Transmitting device 11 has those features but also has a RF signal transmitter 15, which operates at the same time that the acoustic speaker 13 begins transmission. The Super Pass™ device would have to be modified to have this capability in accordance with this invention. Those transmissions are shown schematically in FIG. 1 by lines 19 and 21.

Receiver 23 is shown as a hand held locator unit, but may be mounted in a base station in an alternative embodiment. The preferred embodiment is hand held so that the rescuer can take receiver 23 With him or her as the rescuer searches for the person of interest. Receiver 23 includes a pair of acoustic receivers 25 and 27 that are spaced apart by a predetermined, known distance. Receiver 23 processes the acoustic signal from transmitter 11 and calculates the location of the transmitter by a triangulation calculation. This information is displayed on display 29. Receiver 23 also receives the RF signal from transmitter 11 at kF receiver 31 and processes that signal.

The acoustic signal and the RF signal emitted by the transmitter 11 contain frequent pulses generated simultaneously. This distinctive pulse from the acoustic and RF signals are received by the RF receiver 23 that contains an acoustic receiver and the RF receiver 23 is tuned to receive the RF signal of interest. The RF pulse is received virtually instantaneously while the acoustic pulse will travel at the speed of sound. The difference in arrival times of the acoustic and RF pulse is used to determine distance to the transmitter. The distance is essentially the difference in arrival times divided by the speed of sound. Since the speed of sound is dependent on the existing ambient temperature, both the alarming device 11 and the receiver 23 will contain temperature sensors. The alarming device 11 will imbed the temperature it detects into the RF signal it transmits. The receiving device 23 will receive the temperature and average the value received together with the temperature detected by its own temperature sensor to arrive at an approximate ambient temperature. The exact speed of sound from the averaged acoustic receivers will be determined by a table lookup.

The two acoustic receivers 25 and 27 on receiver 23 Will be spatially separated on two sides of the receiver device. Due to the separation, the acoustic sound will be received by the two receivers 25 and 27 at slightly different times. The difference in time will determine the direction of the alarming device 11 with respect to the receiver device 23. The acoustic receiver that receives the signal first will be closer to the alarming device. Measuring the difference in the times the signal was received by the two acoustic receivers will allow the angle to be determined to the alarming device.

The receiver will contain a display 29, such as a graphical display, that will present to the rescuer the distance and direction to the alarming device. The display 29 may also be imbedded in a IR camera or other person detection device to further enhance the ability to locate the fallen person.

The present invention is intended to be used whenever it is necessary to locate a person when visual sighting is not possible or feasible. A preferred use is in fire fighting in buildings or outside such as in forest or brush fires where smoke and fallen debris prevent visual sighting. Both acoustic and RF signals transmit through smoke and most building walls. The first individual who carries the transmitter may be a fire fighter, medical rescue person, law enforcement officer, military personnel or other person. Similarly the second individual may be any of these persons or a specifically trained rescue person.

While particular embodiments of the present invention have been illustrated and described, it is not intended to limit the invention, except as defined by the following claims.

1. A locator system, comprising:
transmitter device carried by a first individual, said transmitter device being adapted to transmit an acoustic sound pulse and a RF signal pulse;
a receiver device carried by a second individual, said receiver device being adapted to receive said acoustic sound and RF pulses and calculate the distance to and bearing of the transmitter device; and
a display adapted to inform said second individual of said distance and bearing.

2. The system of claim 1, wherein said transmitter device is a PAS device.

3. The system of claim 1, wherein said receiver device is a RF receiver in an IR camera.

4. The system of claim 3, wherein said receiver device has a pair of receivers for receiving said acoustic sound, said pair of acoustic receivers being spaced from each other by a distance sufficient to permit triangulation calculations to determine said distance and bearing.

5. The system of claim 1, transmitter device means is adapted to be activated by said first individual by choice and when said first individual is motionless for a predetermined time.

6. The system of claim 1, wherein said transmitter device includes a temperature sensor and said RF transmitter imbeds temperature data in the RF signal pulses and said RF receiver includes a temperature sensor, whereby said RF receiver calculates the ambient speed of sound prior to said calculations of distance and bearing.

7. The system of claim 1, wherein said display is a graphical display of said distance and bearing.

8. The system of claim 7, wherein said display further displays ambient temperature of said transmitter device at its location.

9. The system of claim 1, wherein said first individual is a first responder in a fire fighting event and wherein said second individual is dispatched to rescue said first individual.

10. A locator system, comprising:
transmitter device means carried by a first individual for transmitting an acoustic sound and a RF pulse;
receiver device means carried by a second individual for receiving said acoustic sound and RF pulse and for calculating the distance to and bearing of the transmitter device means; and
display means for informing said second individual of said distance and bearing.

11. The system of claim 10, wherein said transmitter device means is a PAS device means.

12. The system of claim 11, wherein said receiver device means is mounted in an IR camera means for viewing IR images.

13. The system of claim 10, wherein said RF receiver means has a pair of receiver means for receiving said acoustic sound, said pair of acoustic receiver means being spaced from each other by a distance sufficient to permit triangulation calculations to determine said distance and bearing.

14. The system of claim 10, wherein transmitter device means is adapted to be activated by said first individual by choice and when said first individual is motionless for a predetermined time.

15. The system of claim 10, wherein said transmitter device includes a temperature sensor and said RF transmitter imbeds temperature data in the RF signal pulses and said RF receiver includes a temperature sensor, whereby said RF receiver calculates the ambient speed of sound prior to said calculations of distance and bearing.

16. The system of claim 10, wherein said display is a graphical display of said distance and bearing.

17. The system of claim 10, wherein said display further displays ambient temperature of said transmitter device at its location.

18. The system of claim 10, wherein said first individual is a first responder in a fire fighting event and wherein said second individual is dispatched to rescue said first individual.
